(19) United States
(12) Patent Application Publication
(10) Pub. No.: US 2007/0046100 A1
(43) Pub. Date: Mar. 1, 2007

(54) Rubber track

(75) Inventors: John (Jack) Robert McGilvrey, Ravenna, OH (US); Glenn C. Rabatin, St. Mary's, OH (US); Steven Bell, (US)

Correspondence Address: Roger D. Emerson, Esq.;BROUSE McDOWELL, Suite 500, 388 South Main Street, Akron, OH, 44311-4407, US

(73) Assignee: THE GOODYEAR TIRE & RUBBER COMPANY

(21) Appl. No.: 11/216,367

(22) Filed: Aug. 31, 2005

(51) Int. Cl. B62D 55/24

(52) U.S. Cl. 305/165

(57) ABSTRACT

A rubber track having improved corrosion resistance along the wheel path provided by a polychloroprene layer operatively affixed to the inner surface of the track. The polychlorprene rubber layer may include a polychloroprene rubber selected from WRT type neoprene, W type neoprene, GRT type neoprene, and blends of WRT type neoprene, W type neoprene, and GRT type neoprene.

### I. BACKGROUND OF THE INVENTION

A. Field of Invention

The disclosed invention relates to rubber tracks for motorized vehicles.

B. Description of the Related Art

Molded rubber tracks are, in many cases, being substituted for conventional metal tractor tracks in agricultural and construction vehicles. Rubber tracks may better maneuverability, better ride quality in rough fields, improved side hill stability, excellent traction, low maintenance and greater versatility compared to steel tractor tracks. Additionally, rubber tracks are being used with or even replacing conventional rubber tires on skid steer vehicles, tractors and other agricultural and construction vehicles.

Rubber tracks are defined by an endless elastomeric rubber belt reinforced with continuous flexible cables bonded into the elastomeric material. Generally, rubber tracks are provided with a plurality of guide or drive lugs spaced at defined intervals in the longitudinal direction of the inner surface of the track. These lugs are adapted to engage the wheels of the associated vehicle. Contact between the wheels and the track occurs not only at the surface of the engaged lugs, but at the areas adjacent the lugs.

For standard operations under typical environmental conditions, a reinforced rubber belt is adequately rugged to provide the advantages described above for a long period of use. In certain environments, however, and particularly in applications where the rubber track is subjected to high temperatures and rough, loose grade, the rubber track can degrade, particularly along the wheel path, as hot, abrasive material migrates between the wheels and the track, resulting in shortened life and reduced performance. These harsh environmental conditions are, for example, common in asphalt paving operations, where the rubber tracks on asphalt paving machines not only come into contact with hot asphalt (up to 300 degrees F.), but where hot, rough, asphalt can migrate into the wheel path, causing degradation of the rubber track in the wheel path area.

It is desirable, therefore, to provide a rubber track, particularly suitable for, but not limited to, use in asphalt paving operations, that includes a heat and corrosion resistant protective layer or layers at the wheel path of the rubber track. It is also desirable to provide a protective layer at the wheel path of a rubber track that has adequate adhesion to the surrounding rubber layers. In the past, acrylonitrile has been tried in this context, but the adhesion between the protective layer and the rubber track were shown to be inadequate compared to the material selected for the present invention; namely polychloroprene rubber.

### II. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a front view perspective of a wheel engaging a rubber track and showing the protective layer according to the present invention.

FIG. 2 shows one embodiment of a rubber track according to present invention.

FIG. 3 shows another embodiment of the present invention having a protective layer positioned along the wheel path of the rubber track.

FIG. 4 shows yet another embodiment of the present invention showing a protective layer positioned adjacent the drive lugs of the rubber track.

### III. DESCRIPTION OF THE PREFERRED EMBODIMENT

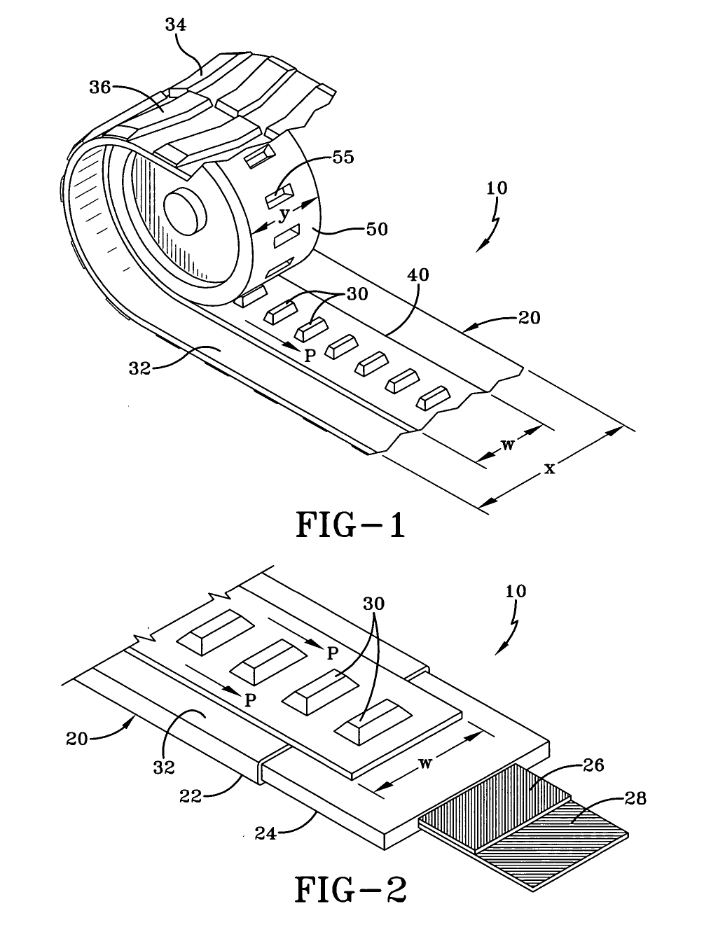

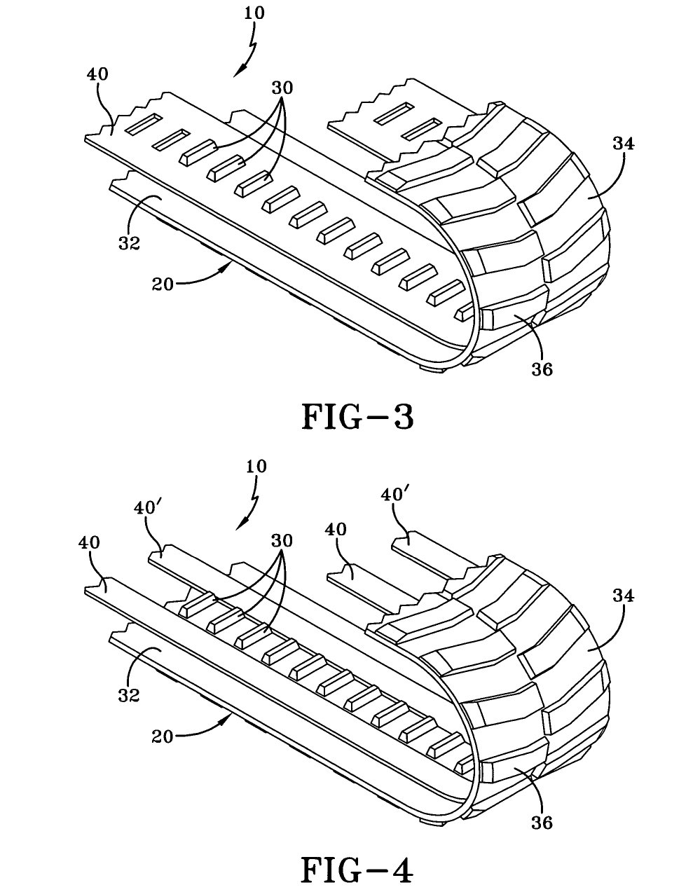

Referring now to the FIGURES, FIGS. 1-4 show an exemplary length of track 10 as may be constructed according to the present invention. The track 10 may be comprised of a plurality of layers. One of the layers may be a reinforced elastomeric belt 20, which may be the radially outwardmost layer. The track may also include a protective layer 40 operatively positioned along the wheel path p adjacent the inner surface of the track 10. The wheel path p is defined as the area of contact on the interior peripheral surface of the track 10 between the track 10 and the wheels or rollers (collectively referred to herein as “wheels”) 50 about which the track 10 is engaged.

The core structure of rubber track 10 and methods of manufacturing the same are generally well known in the art and are taught in such references as U.S. Pat. No. 6,086,811. As such, only a brief recitation of an exemplary structure will be provided prior to a detailed description of the improvement of the present invention. With continued reference to all the FIGURES, but particularly FIG. 2, as noted above, the exemplary track 10 may include an endless elastomeric belt 20, which may include at least a first elastomeric belt layer 24. The at least a first elastomeric belt layer 24 may be reinforced with one or more plies of continuous flexible, reinforcing cables 26, 28 bonded to the at least a first elastomeric belt layer 24. In this way, the elastomeric belt 20 may be called a reinforced elastomeric belt 20. The elastomeric belt 20 may additionally include at least a second elastomeric belt layer 22 located radially adjacent the first elastomeric belt layer 24. The at least a second elastomeric belt layer 22 may or may not be reinforced as described above. It should be noted that the elastomeric belt 20 may be comprised of a wide variety of combinations of elastomeric belt layers 22, 24 and layers of reinforcing materials, including cables 26, 28. All such combinations having an interior peripheral surface 32 to which a protective layer 40 as taught herein may be operatively affixed, are expressly contemplated within this invention and the described embodiment is not intending to be limiting.

The elastomeric compounds suitable for use in the elastomeric belt layers 22, 24 are well known in the art and generally include natural rubber, isoprene, SBR, PBD, and blends of these; however it should be understood that a wide range of elastomeric compounds and blends are suitable for use in the elastomeric belt layers 22, 24 and any such suitable elastomeric material may be selected with sound engineering judgment. The materials suitable for the reinforcing cables 26, 28 are similarly well known in the art and may include but are not limited to, steel, and synthetic fabrics such as nylon, rayon, polyester, Kevlar, fiberglass.

With continued reference to FIGS. 2-4, the exemplary elastomeric belt 20 has an interior peripheral surface 32 and an exterior peripheral surface 34. The exterior peripheral surface 34 of the elastomeric belt 20 may be formed with an integral tread 36 to assist in providing traction. The interior peripheral surface 32 of the elastomeric belt 20 may operatively support a plurality of spaced apart guide lugs 30, which may operatively engage corresponding recesses 55 in the wheels 50 of the associated motorized vehicle (shown in FIG. 1). The guide lugs 30 may be located along the interior peripheral surface centerline of the elastomeric belt 20 as shown in FIGS. 2-4. It is noted, that in some rubber tracks, the guide lugs 30 may be located at the lateral ends or edges of the interior peripheral surface 32 of the elastomeric belt 20. Tracks 10 having this orientation of guide lugs 30 are within the scope of the present invention, though the FIGURES show a track 10 having guide lugs 30 oriented as previously described.

It will be understood that the track 10 is adapted to be positioned upon the wheels 50 of a motorized vehicle such as a skidder loader, tractor, asphalt paving machine, or the like to support the vehicle for movement along a desired surface such as a road, construction site, or an agricultural field. Having described the general structure of the track 10, the improvement is now described.

With reference now to FIGS. 1-4, the track 10 may further include a protective layer 40 adjacently, operatively affixed onto the interior peripheral surface 32 of the elastomeric belt 20. The material selected for the protective layer 40 may have better corrosion resistance than the elastomeric compounds selected for the adjacent elastomeric belt 20. By corrosion resistance, it is meant resistance to degradation resulting from abrasive environmental agents that may migrate into the wheel path, such as, but not limited to gravel, stones, sand, debris, and organic material.

In a first embodiment, the protective layer 40 may be comprised of a first polychloroprene rubber. The first polychloroprene rubber may be selected from the group of neoprene type rubbers, including G-type, T-type, and W-type neoprene rubber, which are commercially available from polymeric suppliers. More specifically, the first polychloroprene rubber may be selected from neoprene GNA-M1, neoprene GNA-M2, neoprene GW, neoprene TW, neoprene TW-100, neoprene W, neoprene WHV, neoprene WHV-100, neoprene WM-1, neoprene WD, neoprene WRT, neoprene WRT-M1, neoprene GRT-M0, neoprene GRT-M1, neoprene GRT-M2, neoprene TRT, and neoprene WB.

According to one embodiment, the protective layer 40 may be comprised of neoprene WRT. The protective layer 40 may consist essentially of neoprene WRT. In an alternative embodiment, the protective layer 40 may include a second polychloroprene rubber, which may be selected from the group of neoprene type rubbers described above. The first and second polychloroprene rubbers may be blended. In one particular embodiment, the first polychlorprene rubber may be neoprene W and the second polychloroprene rubber may be neoprene GRT. In this embodiment, the first and second polychlorprene rubbers may be blended in a ratio of approximately from 0 to 100. In yet further embodiments, other types of neoprene and neoprene blends may be used in accordance with the present invention to construct a protective layer 40.

The protective layer 40 may include but is not limited to other non-polychloroprene rubber components, such as plasticizers, fillers (black and nonblack), curatives, other polymers, processing aids, weather protectants, antidegradants, and resins. Additionally, the protective layer 40 may include other polymers, such as natural rubber or SBR.

As shown in FIGS. 1-4, the protective layer 40 may be deposited on the interior peripheral surface 32 of the elastomeric belt 20 in several formations or orientations. In one embodiment, the protective layer 40 may be deposited in a single strip substantially centered on the longitudinal center line of the interior peripheral surface 32 of the elastomeric belt 20. With respect to this embodiment, the width w of the protective layer 40 may be substantially the same as the width x of the interior peripheral surface 32 of the elastomeric belt 20. Alternatively, the width w of the protective layer 40 may be substantially the same width y as the wheel path p, which may be the width of the widest wheel 50. It should be understood that a variety of different widths w for the protective layer 40 may be selected in accordance with this embodiment, including widths w that are less than the width y of the wheel path and widths w that are between the width y of the wheel path and the width x of the interior peripheral surface 32 of the elastomeric belt 20.

To accommodate the guide lugs 30, the protective layer 40 may be provided with a plurality of holes (not shown) sizeably adapted to permit the guide lugs 30 to pass through the protective layer 40. In this way, the protective layer 40 may be deposited onto the elastomeric belt 20 after the guide lugs 30 have been operatively fixed thereon. Alternatively, the protective layer 40 may be a substantially unbroken layer, which may be deposited onto the elastomeric belt 20 prior to the guide lugs 30 being operatively fixed to thereon. In this embodiment, the guide lugs 30 may be operatively fixed to the track 10 by being attached directly to the protective layer 40. In still yet another embodiment, the protective layer 40 may extend to cover the surfaces of the guide lugs 30, particularly the guide lugs 30 that are within the wheel path P.

In an alternative embodiment, shown in FIG. 4, the protective layer 40 may be deposited onto the interior peripheral surface 32 of the elastomeric belt 20 in more than one strip 40, 40′. For example, to accommodate the guide lugs 30, two strips 40, 40′ of the protective layer could be deposited onto the interior peripheral surface 32 of the elastomeric belt 20, one between each of the outer edges of the elastomeric belt 20 and the guide lugs 30.

In still another embodiment, it may be desirable to protect only the surfaces of the guide lugs 30 that are within the wheel path p, by covering these surfaces with a protective layer 40.

As noted above, some tracks 10 may have guide lugs 30 positioned along the outer edges of the elastomeric belt 20 on the interior peripheral surface 32 thereof. In this embodiment (not shown), as with the embodiments described above, the protective layer 40 may cover substantially the entire interior peripheral surface 32 of the elastomeric belt 20. Alternatively, the protective layer 40 may additionally or exclusively cover the surfaces of the guide lugs 30, or selected portions thereof.

The protective layer 40 thickness is constrained only by design and a nominal design thickness may range from between approximately 0.010 inches and 0.240 inches. The thickness of the protective layer 40 may vary depending on the underlying surface being protected, whether it be the interior peripheral surface 32 of the elastomeric belt 20 or the surfaces of the guide lugs 30.

Many systems for building rubber tracks 10 are known in the art. Typically tracks are built about a cylindrical drum. The drum may have lug pockets or recesses adapted for receiving rubber guide lugs. After guide lugs have been placed into the lug pockets, layers of uncured rubber, calendared cord, and steel wire may be sequentially, selectively placed about the drum. After the layers of the track have been wrapped about the drum, the drum may be heated to cause curing of the rubber and bonding of the layers to form an integrated track. These systems are conducive to incorporating an additional protective layer 40 onto the interior peripheral surface 32 of the elastomeric belt 20 as the protective layer 40 may be sequentially laid down on the cylindrical drum adjacent the innermost elastomeric belt layer (for example, 22 as shown in FIG. 2), which will form the interior peripheral surface 32 of the elastomeric belt 20. The protective layer 40 may thereby be operatively affixed to the interior peripheral surface 32 of the elastomeric belt 20 by heat welding during the curing process. However, it is understood that the protective layer 40 may be operatively affixed to the interior peripheral surface 32 of the elastomeric belt 20 or to the surfaces of the guide lugs 30 by other means, including adhesives, heat welding, and chemical welding or post bonding. The protective layer 40 may be applied during build process, cure process or after cure with or without chemical adhesives.

To form the protective layer 40, the selected polychloroprene compounds may be blended together in an internal mixer and further processed to desired dimensions using equipment such as extruder or calendar.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the fill intended scope of the invention as defined by the following appended claims.

Having thus described the invention, it is now claimed:

I/We claim:

1. A rubber track comprising:
An elastomeric belt having an interior peripheral surface; and
a protective layer operatively affixed to the interior peripheral surface of the elastomeric belt, wherein the protective layer comprises a first polychloroprene rubber.

2. The rubber track of claim 1, wherein the first polychloroprene rubber is selected from the group consisting of WRT type neoprene, W type neoprene, and GRT type neoprene.

3. The rubber track of claim 2, wherein the first polychloroprene rubber consists essentially of WRT type neoprene.

4. The rubber track of claim 1, wherein protective layer comprises a second polychloroprene rubber.

5. The rubber track of claim 4, wherein the first polychloroprene rubber comprises W type neoprene and the second polychloroprene rubber comprises GRT type neoprene.

6. The rubber track of claim 5 wherein the first and second polychloroprene rubbers are blended.

7. The rubber track of claim 6, wherein the ratio of the first polychloprene rubber to the second polychloroprene rubber is approximately from 0 to 100.

8. The rubber track of claim 1, wherein the protective layer is between approximately 0.010 inches and approximately 0.240 inches thick.

9. A rubber track having improved corrosion resistance, the track comprising:
a reinforced elastomeric belt having an interior peripheral surface and an outer peripheral surface; and
a protective layer operatively affixed to the interior peripheral surface of the elastomeric belt, wherein the protective layer comprises a polychloroprene rubber.

10. The rubber track of claim 9, wherein the polychloroprene rubber is selected from the group consisting of WRT type neoprene, W type neoprene, GRT type neoprene, and blends of WRT type neoprene, W type neoprene, and GRT type neoprene.

11. The rubber track of claim 10, wherein the rubber track is adapted to be installed on a motorized vehicle having a wheel path.

12. The rubber track of claim 11, wherein the protective layer is at least as wide as the wheel path.

13. The rubber track of claim 12, wherein the protective layer is wider than the wheel path.

14. The rubber track of claim 11, wherein the motorized vehicle is a motorized asphalt paving vehicle.

15. The rubber track of claim 11, wherein the motorized vehicle is a tractor.

16. A method for constructing a rubber track for use on a motorized vehicle, the method comprising:
forming a reinforced elastomeric belt having an interior peripheral surface;
forming a polychloroprene rubber layer comprising at least a first polychloprene rubber;
operatively affixing the polychloroprene rubber layer onto the interior peripheral surface of the reinforced elastomeric belt.

17. The method of claim 16, wherein the polychloroprene rubber is selected from the group consisting of WRT type neoprene, W type neoprene, GRT type neoprene, and blends of WRT type neoprene, W type neoprene, and GRT type neoprene.

18. The method of claim 17 wherein the motorized vehicle defines having a wheel path width and wherein the polychloroprene rubber layer has a width that is at least the same as the wheel path width.

19. The method of claim 17 wherein the polychloroprene layer is operatively affixed to the reinforced elastomeric belt by heat welding during curing.

20. The method of claim 19, wherein the polychloroprene rubber consists essentially of WRT type neoprene.
